(19) United States
(12) Patent Application Publication
(10) Pub. No.: US 2009/0018725 A1
(43) Pub. Date: Jan. 15, 2009

(54) VEHICLE DYNAMICS CONTROL SYSTEM AND METHOD OF CONTROLLING VEHICLE DYNAMICS

(75) Inventors: Eiichi Ono, Aichi-ken (JP); Yoshikazu Hattori, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Toyota Jidosha Kabushiki Kaisha, Toyota shi, Aichi-ken (JP)

(21) Appl. No.: 12/159,862

(22) PCT Filed: Mar. 30, 2007
(86) PCT No.: PCT/IB2007/000834

§ 371 Date: Jul. 2, 2008

(30) Foreign Application Priority Data
Mar. 31, 2006 (JP) 2006-101066

(51) Int. Cl. B60W 40/06

(52) U.S. Cl. 701/36

(57) ABSTRACT

A vehicle dynamics control system and a method of controlling vehicle dynamics that includes calculating a tire force to achieve target vehicle force and moment; calculating a longitudinal μ rate that a longitudinal force of each tire is normalized with the size of the tire friction circle of each wheel, representing the maximum tire force at each wheel; calculating a steering angle equalized for right and left wheels based on the longitudinal μ rate of each tire, a lateral force of each tire, and a vertical load of each tire; and controlling vehicle dynamics based on the calculated steering angle.

### BACKGROUND OF THE INVENTION

1. Field of the Invention

The present invention relates to a vehicle dynamics control system and a method of controlling the vehicle dynamics. More particularly, the invention relates to a vehicle dynamics control system and a method of controlling the vehicle dynamics using integrated steering-traction/braking control for controlling a steering angle and traction or a steering angle and a braking force in an integrated manner to provide integrated control with an equalized steering angle of right and left wheels.

2. Description of the Related Art

The integrated steering-traction/braking control for controlling the steering angle and traction or braking force of a vehicle in an integrated manner is well known in the art for obtaining target vehicle force and moment indicating a target vehicle longitudinal force, a target vehicle lateral force, and a target yaw moment. In this integrated steering-traction/braking control, steering and traction/braking are independently controlled for each wheel such that the magnitude and the direction of force at each wheel are calculated and obtained for maximizing the tire grip margin of each wheel, that is, for minimizing the μ rate of each wheel (see, e.g., JP-A-2004-249971). Here, the symbol μ denotes the coefficient of friction between a tire and the road.

However, the magnitude of the force at each wheel calculated in the above related art may often differ from each other due to the respective calculations for wheels. Therefore, independent steering of the right and left wheels is required to obtain the calculated tire force of each wheel. The above control is thus not suitable for vehicles that have a steering mechanism that only can control the steering with an identical steering angle at the right and left wheels.

### SUMMARY OF THE INVENTION

The present invention provides a vehicle dynamics control system and a method of controlling the vehicle dynamics such that calculations are performed to obtain the equalized steering angle of right and left wheels during an integrated steering-traction/braking control and therefore the integrated steering-traction/braking control suitable even for vehicles having a steering mechanism that only can control with the identical steering angle for right and left wheels.

A first aspect of the present invention is directed to a vehicle dynamics control system including tire force calculation means for calculating a tire force at each wheel to achieve target vehicle force and target vehicle moment that indicates the target vehicle longitudinal force, a target vehicle lateral force, and a target yaw moment; longitudinal μ rate calculation means for calculating a longitudinal μ rate, which is obtained by normalizing a longitudinal force of each tire with a size of each tire friction circle representing the maximum tire force of each wheel; steering angle calculation means for calculating a steering angle equalized for the right and left wheels based on the longitudinal μ rate of each tire, a lateral force of each tire, and a vertical load of each tire; and control means for controlling vehicle dynamics based on the calculated steering angle.

A second aspect of the present invention is directed to a method of controlling vehicle dynamics that includes calculating a tire force of each wheel to achieve target vehicle force and moment indicating a target vehicle longitudinal force, a target vehicle lateral force, and a target yaw moment; calculating a longitudinal μ rate, which is obtained by normalizing a longitudinal force of each tire with the size of each tire friction circle representing the maximum tire force of each wheel; calculating a steering angle equalized for right and left wheels based on the longitudinal μ rate of each tire, a lateral force of each tire, and a vertical load of each tire; and controlling vehicle dynamics based on the steering angle calculated.

A third aspect of the present invention is directed to a vehicle dynamics control system that includes a tire force calculation section for calculating a tire force of each wheel to achieve target vehicle force and moment indicating a target vehicle longitudinal force, a target vehicle lateral force, and a target yaw moment; a longitudinal μ rate calculation section for calculating a longitudinal μ rate, which is obtained by normalizing a longitudinal force of each tire with a size of each tire friction circle representing the maximum tire force of each wheel; a steering angle calculation section for calculating a steering angle equalized for right and left wheels based on the longitudinal μ rate of each tire, a lateral force of each tire, and a vertical load of each tire; and a control section for controlling vehicle dynamics based on the steering angle calculated.

In the above aspects, it is found that a specific relation is always achieved between the longitudinal μ rate and decreasing characteristics of the lateral force along with the longitudinal force irrespective of road friction or the steering angle. By using this finding, the lateral force is distributed to the right and left wheels in order to obtain an equalized steering angle for the right and left wheels, and the vehicle is intended to be controlled with the equalized steering angle for the right and left wheels obtained by calculations in an integrated manner. Thus, the equalized steering angle for the right and left wheels is calculated by using the tire force of each wheel optimally calculated subject to four-wheel distributed steering in order to maintain the sum of the lateral forces generated on right and left tires of front or rear wheels. Therefore, the vehicle is controlled with the equalized steering angle for the right and left wheels in an integrated manner.

The steering angle equalized for the right and left wheels is calculated by approximating with a parabola the relation between the longitudinal μ rate in case of a constant lateral slip and a normalized lateral force that the lateral force of each tire is normalized with the maximum lateral force, and by distributing an optimum lateral force of each tire for achieving the target vehicle force and moment assuming that the lateral force, when a longitudinal slip equals to zero, is proportional to a vertical load and based on a ratio of the lateral force of each tire when the lateral slip of right and left tires are the same.

According to the above aspects, because the equalized steering angle for right and left wheels is calculated when performing the integrated steering-traction/braking control, the integrated steering-traction/braking control can be adapted to even the vehicle having a steering mechanism that only can control with an identical steering angle for right and left wheels.

### BRIEF DESCRIPTION OF THE DRAWINGS

The foregoing and/or further objects, features and advantages of the invention will become more apparent from the following description of example embodiments with reference to the accompanying drawings, in which like numerals are used to represent like elements and wherein:

FIG. 1 is a schematic diagram illustrating a vehicle dynamics model.

FIG. 2 is a block diagram showing an embodiment of the present invention.

FIG. 3 is a block diagram showing the details of the μ rate and steering angle calculation means of FIG. 2.

FIG. 4 is a chart showing the relation between lateral and longitudinal forces in a constant lateral slip.

FIG. 5 is a chart showing the relation between normalized lateral and longitudinal forces in FIG. 4.

FIG. 6A is a schematic diagram showing an optimum solution of four-wheel distributed steering.

FIG. 6B is a schematic diagram showing a solution with the equalized steering angle of right and left wheels.

### DETAILED DESCRIPTION OF THE PREFERRED EMBODIMENTS

In the following description, the present invention will be described in more detail in terms of example embodiments.

One embodiment of the present invention will be described hereinafter in detail with reference to accompanying drawings. First, the principle of a coordinate control between steering and traction and between steering and braking in a vehicle with four-wheel distributed steering and traction/braking system, in other words, integrated control, will be described.

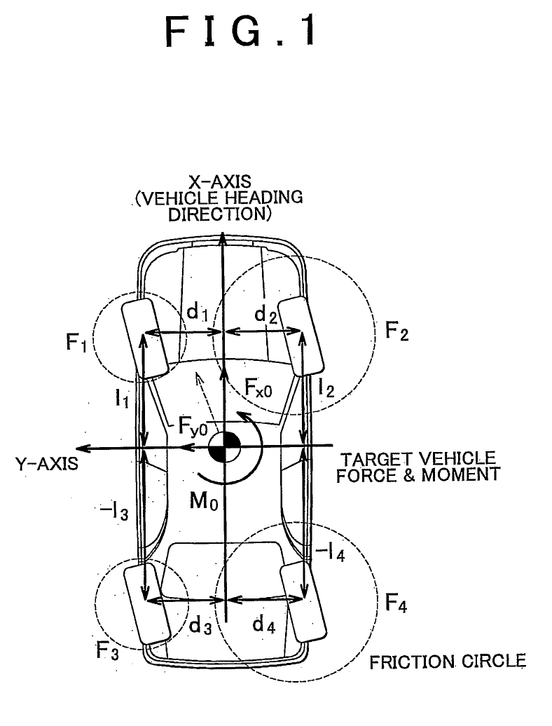

FIG. 1 shows a vehicle dynamics model with four wheels. Resultant of tire forces acting on each wheel and applied to the vehicle body in order to achieve the desired vehicle motion by a driver is represented in a general coordinate system having an X-axis extending in the longitudinal direction of the vehicle body.

Assuming that the sizes of friction circles Fᵢ of wheels are known (where, i=1, 2, 3, and 4, and 1: left front wheel, 2: right front wheel, 3: left rear wheel, and 4: right rear wheel), the directions of the tire force and the μ rate of the wheels are evaluated in order to minimize the upper limit of the μ rate of wheel (maximum value in four wheels), while the designated target vehicle force (longitudinal force Fₓ₀, and lateral force F_{y0}) and target yaw moment M_{z0} (target vehicle force and moment) are attained. The size of the friction circle of each tire is expressed as the magnitude of the maximum tire force at each wheel and estimated from factors such as load or speed of each wheel and Self-Aligning Torque.

First, a constraint is modeled that the target resultant of vehicle forces and the target yaw moment (target vehicle force and moment) are gained. When the coordinate conversion is performed such that the direction of the resultant of tire forces is converted to X-axis and the direction perpendicular to the X-axis to Y-axis, tire positions (x, y)=(lᵢ, dᵢ) are defined as the following Eqs. (1) to (8).

$$\begin{matrix}{l}_{1} = {L}_{f} & ( 1 ) \\ {l}_{2} = {L}_{f} & ( 2 ) \\ {l}_{3} = - {L}_{r} & ( 3 ) \\ {l}_{4} = - {L}_{r} & ( 4 ) \\ {d}_{1} = \frac{{T}_{f}}{2} & ( 5 ) \\ {d}_{2} = - \frac{{T}_{f}}{2} & ( 6 ) \\ {d}_{3} = \frac{{T}_{r}}{2} & ( 7 ) \\ {d}_{4} = - \frac{{T}_{r}}{2} & ( 8 )\end{matrix}$$

Here, T_{f} is the front wheel track, Tᵣ is the rear wheel track, L_{f} is the distance between the center of gravity of the vehicle and the midpoint of the front wheel track, Lᵣ, is a distance between the center of gravity of the vehicle and the midpoint of the rear wheel track, lᵢ is the distance between X-axis and a ground contact point of a tire, and dᵢ is a distance between Y-axis and a ground contact point of a tire.

If the upper limit of μ rate at each wheel is γ, the tire μ rate representing the ratio to the upper limit γ at each wheel is rᵢ, and the direction of each tire force is qᵢ (the counter clockwise direction be the positive direction on the X-axis), the tire forces at each wheel (Fₓᵢ, F_{yi}) may be expressed as the following Eqs. (9) and (10).

Fₓᵢ=γrᵢFᵢ cos qᵢ (9)

F_{yi}=γrᵢFᵢ sin qᵢ (10)

The vehicle forces (longitudinal force Fₓ₀ and lateral force F_{y0}), which are the resultants of the tire forces at the wheels, and the yaw moment M_{z0} may be expressed with the following constraints.

$$\begin{matrix}γ {\sum }_{i = 1}^{4} {r}_{i} {F}_{i} cos {q}_{i} = {F}_{x 0} & ( 11 ) \\ γ {\sum }_{i = 1}^{4} {r}_{i} {F}_{i} sin {q}_{i} = {F}_{y 0} & ( 12 ) \\ γ {\sum }_{i = 1}^{4} {r}_{i} {F}_{i} ( - {d}_{i} cos {q}_{i} + {l}_{i} sin {q}_{i} ) = {M}_{z 0} & ( 13 )\end{matrix}$$

When both sides of the Eq. (11) are multiplied by the lateral force F_{y0}, both sides of the Eq. (12) are multiplied by the longitudinal force Fₓ₀, and the resulting Eq. (12) is subtracted from the resulting Eq. (11), the following Eq. (14) that the upper limit γ or μ rate is eliminated is derived.

$$- {F}_{y 0} {\sum }_{i = 1}^{4} {r}_{i} {F}_{i} cos {q}_{i} + {F}_{x 0} {\sum }_{i = 1}^{4} {r}_{i} {F}_{i} sin {q}_{i} = 0. \qquad ( 14 )$$

When both sides of the Eq. (11) are multiplied by the moment M_{z0}, both sides of the Eq. (13) are multiplied by the longitudinal force Fₓ₀ and the resulting Eq. (13) is subtracted from the resulting Eq. (11), the following Eq. (15) that the upper limit γ is eliminated is derived.

$$- {M}_{z 0} {\sum }_{i = 1}^{4} {r}_{i} {F}_{i} cos {q}_{i} + {F}_{x 0} {\sum }_{i = 1}^{4} {r}_{i} {F}_{i} ( - {d}_{i} cos {q}_{i} + {l}_{i} sin {q}_{i} ) = 0 \qquad ( 15 )$$

In addition, when the both sides of the Eq. (12) are multiplied by the yaw moment M_{z0}, the both sides of the Eq. (13) are multiplied by the lateral force F_{y0}, and the resulting Eq. (13) is subtracted from the resulting Eq. (12), the following Eq. (16) that the upper limit γ of μ rate is eliminated is derived.

$$- {M}_{z 0} {\sum }_{i = 1}^{4} {r}_{i} {F}_{i} sin {q}_{i} + {F}_{y 0} {\sum }_{i = 1}^{4} {r}_{i} {F}_{i} ( - {d}_{i} cos {q}_{i} + {l}_{i} sin {q}_{i} ) = 0 \qquad ( 16 )$$

Then, adding both of the Eqs. (14) to (16) that the upper limit γ of μ rate is eliminated derives the following Eq. (17).

$${\sum }_{i = 1}^{4} {r}_{i} {F}_{i} \{ \begin{matrix}( - {d}_{i} {F}_{x 0} - {d}_{i} {F}_{y 0} - {F}_{y 0} - {M}_{z 0} ) cos {q}_{i} + \\ ( {l}_{i} {F}_{x 0} + {l}_{i} {F}_{y 0} + {F}_{x 0} - {M}_{z 0} ) sin {q}_{i}\end{matrix} \} = 0. \qquad ( 17 )$$

When the both sides of Eqs. (11), (12), and (13) are multiplied by d₀²Fₓ₀, l₀²F_{y0}, and M_{z0}, respectively, and the resulting three equations are added, the following Eq. (18) is derived.

$$γ {\sum }_{i = 1}^{4} {r}_{i} {F}_{i} \{ ( {d}_{0}^{2} {F}_{x 0} - {d}_{i} {M}_{z 0} ) cos {q}_{i} + ( {l}_{0}^{2} {F}_{y 0} + {l}_{i} {M}_{z 0} ) sin {q}_{i} \} = {( {d}_{0} {{F}_{x}}_{0} )}^{2} + {( {l}_{0} {F}_{y 0} )}^{2} + {M}_{z 0}^{2} \qquad ( 18 )$$

Here, d₀ and l₀ are constants that respectively adjust the dimensions of the force and moment. In this embodiment, the d₀ and l₀ are defined as the following Eqs. (19) and (20).

$$\begin{matrix}{d}_{0} = \frac{{T}_{f} + {T}_{r}}{4} & ( 19 ) \\ {l}_{0} = \frac{{L}_{f} + {L}_{r}}{2} & ( 20 )\end{matrix}$$

The magnitude M_{F0} of the target vehicle force and moment is defined through the following Eq. (21).

$${M}_{F 0} ≡ \sqrt{{( {d}_{0} {F}_{x 0} )}^{2} + {( {l}_{0} {F}_{y 0} )}^{2} + {M}_{z 0}^{2}} \qquad ( 21 )$$

The constraints are used in the following Eqs. (22) and (23) that are derived by eliminating the upper limit γ of μ rate from Eqs. (13) and (18) and normalized with the magnitude M_{F0} of the target vehicle force and moment.

$$\begin{matrix}{\sum }_{i = 1}^{4} {r}_{i} {F}_{i} ( \begin{matrix}\frac{- {d}_{i} {F}_{x 0} - {d}_{i} {F}_{y 0} - {F}_{y 0} - {M}_{z 0}}{{M}_{F 0}} cos {q}_{i} + \\ \frac{{l}_{i} {F}_{x 0} + {l}_{i} {F}_{y 0} + {F}_{x 0} - {M}_{z 0}}{{M}_{F 0}} sin {q}_{i}\end{matrix} ) = 0 & ( 22 ) \\ {\sum }_{i = 1}^{4} {r}_{i} {F}_{i} \{ \begin{matrix}\frac{{M}_{z 0} ( {d}_{0}^{2} {F}_{x 0} - {d}_{i} {M}_{z 0} ) + {d}_{i} {M}_{F 0}^{2}}{{M}_{F 0}^{2}} cos {q}_{i} + \\ \frac{{M}_{z 0} ( {l}_{0}^{2} {F}_{y 0} + {l}_{i} {M}_{z 0} ) - {l}_{i} {M}_{F 0}^{2}}{{M}_{F 0}^{2}} sin {q}_{i}\end{matrix} \} = 0 & ( 23 )\end{matrix}$$

The constraints of the above Eqs. (22) and (23) work when any two of Fₓ₀, F_{y0}, and M_{z0} become zero. The normalization is performed for improving the computation accuracy in the fixed-point arithmetic using a computer such as an ECU or a program.

The following Eq. (24) is defined as a performance function J intending to minimize the upper limit γ of μ rate.

$$J = \frac{{( {d}_{0} {F}_{x 0} )}^{2} + {( {l}_{0} {F}_{y 0} )}^{2} + {M}_{z 0}^{2}}{γ} = \frac{{M}_{F 0}^{2}}{γ} \qquad ( 24 )$$

This performance function is expressed as (constant)/(upper limit γ of μ rate), and maximizing the solution of the Eq. (24) implies minimizing the μ rate. By substitution of the above Eq. (18) into the performance function, the performance function is expressed as the following Eq. (25).

$$\begin{matrix}J = \frac{{( {d}_{0} {F}_{x 0} )}^{2} + {( {l}_{0} {F}_{y 0} )}^{2} + {M}_{z 0}^{2}}{γ} \\ = {\sum }_{i = 1}^{4} {r}_{i} {F}_{i} \{ ( {d}_{0}^{2} {F}_{x 0} - {d}_{l} {M}_{z 0} ) cos {q}_{i} + ( {l}_{0}^{2} {F}_{y 0} + {l}_{i} {M}_{z 0} ) sin {q}_{i} \}\end{matrix} \qquad ( 25 )$$

When the direction of each tire force qᵢ and the tire μ rate rᵢ are obtained for maximizing the solution of the Eq. (25), the upper limit γ of μ rate is minimized.

Therefore, the nonlinear optimization problem can be formulated as follows. That is, the direction of each tire force qᵢ and the tire μ rate rᵢ are derived in order to satisfy the constraints of the Eqs. (22) and (23) and to maximize the solution of the Eq. (25).

A distribution algorithm of each tire force is described next. In addition to the problem of the related art that the μ rate of each wheel is equally determined, this embodiment requires to include the tire μ rate rᵢ into parameters. In this embodiment, a repeat operation is performed using the algorithm for individually optimizing the direction of each tire force qᵢ and the tire μ rate rᵢ each time, so that the direction of each tire force qᵢ and the tire μ rate rᵢ can be obtained.

To find a constant μ rate friction circle, the direction of each tire force qᵢ is first solved using a sequential quadratic programming algorithm as the related art with the tire u rate rᵢ fixed.

By performing first-order approximation of sin qᵢ and cos qᵢ as the following Eqs. (26) and (27), the constraints of the above Eqs. (22) and (23) can be linearized relative to the direction of each tire force qᵢ as the following Eqs. (28) and (29).

$$\begin{matrix}sin {q}_{i} = sin {q}_{i 0} + cos {q}_{10} ( {q}_{i} - {q}_{i 0} ) & ( 26 ) \\ cos {q}_{i} = cos {q}_{i 0} - sin {q}_{i 0} ( {q}_{i} - {q}_{i 0} ) & ( 27 ) \\ {\sum }_{i = 1}^{4} {r}_{i} {F}_{i} ( \begin{matrix}\frac{{d}_{i} {F}_{x 0} + {d}_{l} {F}_{y 0} + {F}_{y 0} + {M}_{z 0}}{{M}_{F 0}} sin {q}_{i 0} + \\ \frac{{l}_{i} {F}_{x 0} + {l}_{i} {F}_{y 0} + {F}_{x 0} - {M}_{z 0}}{{M}_{F 0}} cos {q}_{i 0}\end{matrix} ) {q}_{i} = {\sum }_{i = 1}^{4} {r}_{i} {F}_{i} \{ \begin{matrix}\frac{{d}_{i} {F}_{x 0} + {d}_{i} {F}_{y 0} + {F}_{y 0} + {M}_{z 0}}{{M}_{F 0}} ( {q }_{i 0} sin {q}_{i 0} + cos {q}_{i} ) + \\ \frac{{l}_{i} {F}_{x 0} + {l}_{i} {F}_{y 0} + {F}_{x 0} - {M}_{z 0}}{{M}_{F 0}} ( {q}_{i 0} cos {q}_{i 0} - sin {q}_{i 0} )\end{matrix} \} & ( 28 ) \\ {\sum }_{i = 1}^{4} {r}_{i} {F}_{i} \{ \begin{matrix}- \frac{{M}_{z 0} ( {d}_{0}^{2} {F}_{x 0} - {d}_{i} {M}_{z 0} ) + {d}_{i} {M}_{F 0}^{2}}{{M}_{F 0}^{2}} sin {q}_{i 0} + \\ \frac{{M}_{z 0} ( {l}_{0}^{2} {F}_{y 0} + {l}_{i} {M}_{z 0} ) - {l}_{i} {M}_{F 0}^{2}}{{M}_{F 0}^{2}} cos {q}_{i 0}\end{matrix} \} {q}_{i} = {\sum }_{i = 1}^{4} {r}_{i} {F}_{i} \{ \begin{matrix}- \frac{{M}_{z 0} ( {d}_{0}^{2} {F}_{x 0} - {d}_{i} {M}_{z 0} ) + {d}_{i} {M}_{F 0}^{2}}{{M}_{F 0}^{2}} ( {q}_{i 0} sin {q}_{i 0} + cos {q}_{i} ) + \\ \frac{{M}_{z 0} ( {l}_{0}^{2} {F}_{y 0} + {l}_{i} {M}_{z 0} ) {l}_{i} {M}_{F 0}^{2}}{{M}_{F 0}^{2}} ( {q}_{i 0} cos {q}_{i 0} - sin {q}_{i 0} )\end{matrix} \} & ( 29 )\end{matrix}$$

When sin qᵢ and cos qᵢ are approximated by a second-order Taylor expansion as the following Eqs. (30) and (31), the performance function J of the above Eq. (25) is expressed as the following Eq. (32).

$$\begin{matrix}sin {q}_{i} = sin {q}_{i 0} + cos {q}_{i 0} ( {q}_{i} - {q}_{i 0} ) - \frac{sin {q}_{i 0}}{2} {( {q}_{i} - {q}_{i 0} )}^{2} & ( 30 ) \\ cos {q}_{i} = cos {q}_{i 0} - sin {q}_{i 0} ( {q}_{i} - {q}_{i 0} ) - \frac{cos {q}_{i 0}}{2} {( {q}_{i} - {q}_{i 0} )}^{2} & ( 31 ) \\ J = {\sum }_{i = 1}^{4} {r}_{i} {F}_{i} [ \begin{matrix}\begin{matrix}\begin{matrix}- \frac{1}{2} \{ ( {d}_{0}^{2} {F}_{x 0} - {d}_{i} {M}_{z 0} ) cos {q}_{i 0} + ( {l}_{0}^{2} {F}_{y 0} + {l}_{i} {M}_{z 0} ) sin {q}_{i 0} \} {q}_{i}^{2} + \\ \{ \begin{matrix}( {d}_{0}^{2} {F}_{x 0} - {d}_{i} {M}_{z 0} ) ( {q}_{i 0} cos {q}_{i 0} - sin {q}_{i 0} ) + \\ ( {l}_{0}^{2} {F}_{y 0} + {l}_{i} {M}_{z 0} ) ( {q}_{i 0} sin {q}_{i 0} + cos {q}_{i 0} )\end{matrix} \} {q}_{i} +\end{matrix} \\ ( {d}_{0}^{2} {F}_{x 0} - {d}_{i} {M}_{z 0} ) \{ ( 1 - \frac{{q}_{i 0}^{2}}{2} ) cos {q}_{i 0} + {q}_{i 0} sin {q}_{i 0} \} +\end{matrix} \\ ( {l}_{0}^{2} {F}_{y 0} + {l}_{i} {M}_{z 0} ) \{ ( 1 - \frac{{q}_{i 0}^{2}}{2} ) sin {q}_{i 0} - {q}_{i 0} cos {q}_{i 0} \}\end{matrix} ] = {\sum }_{i = 1}^{4} {r}_{i} {F}_{i} \{ - \frac{1}{2} {{X}_{Di} ( {q}_{i} - {X}_{i} )}^{2} + {Y}_{i} \} \\ where , & ( 32 ) \\ {X}_{i} = \frac{{X}_{Ni}}{{X}_{Di}} & ( 33 ) \\ {X}_{N i} = ( {d}_{0}^{2} {F}_{x 0} - {d}_{i} {M}_{z 0} ) ( {q}_{i 0} cos {q}_{i 0} - sin {q}_{i 0} ) + ( {l}_{0}^{2} {F}_{y 0} + {l}_{i} {M}_{z 0} ) ( {q}_{i 0} sin {q}_{i 0} + cos {q}_{i 0} ) & ( 34 ) \\ {X}_{Di} = ( {d}_{0}^{2} {F}_{x 0} - {d}_{i} {M}_{z 0} ) cos {q}_{i 0} + ( {l}_{0}^{2} {F}_{y 0} + {l}_{i} {M}_{z 0} ) sin {q}_{i 0} & ( 35 ) \\ {Y}_{i} = ( {d}_{0}^{2} {F}_{x 0} - {d}_{i} {M}_{z 0} ) \{ ( 1 - \frac{{q}_{i 0}^{2}}{2} ) cos {q}_{i 0} + {q}_{i 0} sin {q}_{i 0} \} + ( {l}_{0}^{2} {F}_{y 0} + {l}_{i} {M}_{z 0} ) \{ ( 1 - \frac{{q}_{i 0}^{2}}{2} ) sin {q}_{i 0} - {q}_{i 0} cos {q}_{i 0} \} + \frac{{X}_{Ni}^{2}}{2 {X}_{Di}} & ( 36 )\end{matrix}$$

By transforming variables as the following Eq. (37), the performance function J of the Eq. (25) is expressed as the following Eq. (38) and transformed to the minimization of p-Euclidean norm.

$$\begin{matrix}{p}_{i} = \sqrt{{r}_{i} {F}_{i} {X}_{Di}} ( {q}_{i} - {X}_{i} ) & ( 37 ) \\ J = {\sum }_{i = 1}^{4} ( - \frac{1}{2} {p}_{i}^{2} + {r}_{i} {F}_{i} {Y}_{i} ) = - \frac{1}{2} {‖ p ‖}^{2} + {\sum }_{i = 1}^{4} {r}_{i} {F}_{i} {Y}_{i} \\ where , \\ p = {[ {p}_{1} {p}_{2} {p}_{3} {p}_{4} ]}^{T} & ( 38 )\end{matrix}$$

The linearly approximated constraints are expressed as the following Eq. (39).

$$\begin{matrix}[ \begin{matrix}{A}_{11} & {A}_{12} & {A}_{13} & {A}_{14} \\ {A}_{21} & {A}_{22} & {A}_{23} & {A}_{24}\end{matrix} ] p = [ \begin{matrix}{B}_{1} \\ {B}_{2}\end{matrix} ] \\ where , & ( 39 ) \\ {A}_{li} = \sqrt{\frac{{r}_{i} {F}_{i}}{{X}_{Di}}} \cdot ( \begin{matrix}\frac{{d}_{i} {F}_{x 0} + {d}_{i} {F}_{y 0} + {F}_{y 0} + {M}_{z 0}}{{M}_{F 0}} sin {q}_{i 0} + \\ \frac{{l}_{i} {F}_{x 0} + {l}_{i} {F}_{y 0} + {F}_{x 0} - {M}_{z 0}}{{M}_{F 0}} cos {q}_{i 0}\end{matrix} ) & ( 40 ) \\ {A}_{2 i} = \sqrt{\frac{{r}_{i} {F}_{i}}{{X}_{Di}}} \cdot \{ \begin{matrix}- \frac{{M}_{z 0} ( {d}_{0}^{2} {F}_{x 0} - {d}_{i} {M}_{2 \; 0} ) + {d}_{i} {M}_{F 0}^{2}}{{M}_{F 0}^{2}} sin {q}_{i 0} + \\ \frac{{M}_{z 0} ( {l}_{0}^{2} {F}_{y 0} + {l}_{i} {M}_{z 0} ) - {l}_{i} {M}_{F 0}^{2}}{{M}_{F 0}^{2}} cos {q}_{i 0}\end{matrix} \} & ( 41 ) \\ {B}_{1} = {\sum }_{i = 1}^{4} {r}_{i} {F}_{i} [ \begin{matrix}\frac{{d}_{i} {F}_{x 0} + {d}_{i} {F}_{y 0} + {F}_{y 0} + {M}_{z 0}}{{M}_{F 0}} \{ ( {q}_{i 0} - {X}_{i} ) sin {q}_{i 0} + cos {q}_{i 0} \} + \\ \frac{{l}_{i} {F}_{x 0} + {l}_{i} {F}_{y 0} + {F}_{x 0} - {M}_{z 0}}{{M}_{F 0}} \{ ( {q}_{i 0} - {X}_{i} ) cos {q}_{i 0} - sin {q}_{i 0} \}\end{matrix} ] & ( 42 ) \\ {B}_{2} = {\sum }_{i = 1}^{4} {r}_{i} {F}_{i} [ \begin{matrix}- \frac{{M}_{z 0} ( {d}_{0}^{2} {F}_{x 0} - {d}_{i} {M}_{z 0} ) + {d}_{i} {M}_{F 0}^{2}}{{M}_{F 0}^{2}} \{ ( {q}_{i 0} - {X}_{i} ) sin {q}_{i 0} + cos {q}_{i 0} \} + \\ \frac{{M}_{z 0} ( {l}_{0}^{2} {F}_{y 0} + {l}_{i} {M}_{z 0} ) - {l}_{i} {M}_{F 0}^{2}}{{M}_{F 0}^{2}} \{ ( {q}_{i 0} - {X}_{i} ) cos {q}_{i 0} - sin {q}_{i 0} \}\end{matrix} ] & ( 43 )\end{matrix}$$

The minimal solution of Euclidean norm for satisfying the above Eq. (39) is derived by using the following Eq. (44).

$$p = {[ \begin{matrix}{A}_{11} & {A}_{12} & {A}_{13} & {A}_{14} \\ {A}_{21} & {A}_{22} & {A}_{23} & {A}_{24}\end{matrix} ]}^{+} \cdot [ \begin{matrix}{B}_{1} \\ {B}_{2}\end{matrix} ] \qquad ( 44 )$$

Here, A⁺ represents the pseudo-inverse of matrix A.

The direction of each tire force q is expressed as the following Eq. (45)

$$q = diag [ \frac{1}{\sqrt{{r}_{1} {F}_{1} {X}_{D 1}}} \frac{1}{\sqrt{{r}_{2} {F}_{2} {X}_{D 2}}} \frac{1}{\sqrt{{r}_{3} {F}_{3} {X}_{D 3}}} \frac{1}{\sqrt{{r}_{4} {F}_{4} {X}_{D 4}}} ] \cdot {[ \begin{matrix}{A}_{11} & {A}_{12} & {A}_{13} & {A}_{14} \\ {A}_{21} & {A}_{22} & {A}_{23} & {A}_{24}\end{matrix} ]}^{+} \cdot [ \begin{matrix}{B}_{1} \\ {B}_{2}\end{matrix} ] + [ \begin{matrix}{X}_{1} \\ {X}_{2} \\ {X}_{3} \\ {X}_{4}\end{matrix} ] \qquad ( 45 )$$

According to the direction of each tire force qᵢ (=q₁, q₂, q₃, q₄), q is expressed as the following equation.

q=[q₁q₂q₃q₄]^{T}

Here, a penalty function P is defined as the following Eq. (46) where ρ is a positive constant (1.0). When the penalty function of Eq. (46) is calculated by using the direction of each tire force qᵢ derived in Eq. (45) and if the penalty function P shows a decline, convergence calculations are performed in a recursive manner that calculations of Eqs. (33) to (35), Eqs. (40) to (43), and Eq. (45) are repeatedly performed.

$$\begin{matrix}P = \frac{1}{J} + ρ ( \vert {J}_{1} \vert + \vert {J}_{2} \vert ) \\ where , & ( 46 ) \\ {J}_{1} = {\sum }_{i = 1}^{4} {r}_{i} {F}_{i} ( \begin{matrix}\frac{- {d}_{i} {F}_{x 0} - {d}_{i} {F}_{y 0} - {F}_{y 0} - {M}_{z 0}}{{M}_{F 0}} cos {q}_{i} + \\ \frac{{l}_{i} {F}_{x 0} + {l}_{i} {F}_{y 0} + {F}_{x 0} - {M}_{z 0}}{{M}_{F 0}} sin {q}_{i}\end{matrix} ) & ( 47 ) \\ {J}_{2} = {\sum }_{i = 1}^{4} {r}_{i} {F}_{i} \{ \begin{matrix}\frac{{M}_{z 0} ( {d}_{0}^{2} {F}_{x 0} - {d}_{i} {M}_{z 0} ) + {d}_{i} {M}_{F 0}^{2}}{{M}_{F 0}^{2}} cos {q}_{i} \\ \frac{{M}_{z 0} ( {l}_{0}^{2} {F}_{y 0} + {l}_{i} {M}_{z 0} ) - {l}_{i} {M}_{F 0}^{2}}{{M}_{F 0}^{2}} sin {q}_{i}\end{matrix} \} & ( 48 )\end{matrix}$$

The μ rate using the direction of each tire force qᵢ derived by the above algorithm is calculated with the following Eq. (49) derived from Eqs. (24) and (28). The Eq. (49) shows that the μ rate is defined as the proportion of the square of the magnitude of the target vehicle force and moment on the performance function.

$$γ = \frac{{( {d}_{0} {F}_{x 0} )}^{2} + {( {l}_{0} {F}_{y 0} )}^{2} + {M}_{z 0}^{2}}{{\sum }_{i = 1}^{4} {r}_{i} {F}_{i} \{ ( {d}_{0}^{2} {F}_{x 0} - {d}_{l} {M}_{z 0} ) cos {q}_{i} + ( {l}_{0}^{2} {F}_{y 0} + {l}_{i} {M}_{z 0} ) sin {q}_{i} \}} \qquad ( 49 )$$

The correction of tire μ rate will be described next. When the tire μ rate rᵢ (=r₁, r₂, r₃, r₄) is changed to rᵢ+drᵢ (where drᵢ is an amount of change) and corrected, the above Eqs. (22) and (23) representing the constraints of the target vehicle force and moment are expressed as the following Eqs. (50) and (51).

$$\begin{matrix}{\sum }_{i = 1}^{4} {r}_{i} {F}_{i} ( \begin{matrix}\frac{- {d}_{i} {F}_{x 0} - {d}_{i} {F}_{y 0} - {F}_{y 0} - {M}_{z 0}}{{M}_{F 0}} cos {q}_{i} + \\ \frac{{l}_{i} {F}_{x 0} + {l}_{i} {F}_{y 0} + {F}_{x 0} - {M}_{z 0}}{{M}_{F 0}} sin {q}_{i}\end{matrix} ) = {Δ}_{1} ( dr ) & ( 50 ) \\ {\sum }_{i = 1}^{4} {r}_{i} {F}_{i} \{ \begin{matrix}\frac{{M}_{z 0} ( {d}_{0}^{2} {F}_{x 0} - {d}_{i} {M}_{z 0} ) + {d}_{i} {M}_{F 0}^{2}}{{M}_{F 0}^{2}} cos {q}_{i} \\ \frac{{M}_{z 0} ( {l}_{0}^{2} {F}_{y 0} + {l}_{i} {M}_{z 0} ) - {l}_{i} {M}_{F 0}^{2}}{{M}_{F 0}^{2}} sin {q}_{i}\end{matrix} \} = {Δ}_{2} ( dr ) \\ where , & ( 51 ) \\ {Δ}_{1} ( dr ) = - {\sum }_{i = 1}^{4} {dr}_{i} {F}_{i} ( \begin{matrix}\frac{- {d}_{i} {F}_{x 0} - {d}_{i} {F}_{y 0} - {F}_{y 0} - {M}_{z 0}}{{M}_{F 0}} cos {q}_{i} + \\ \frac{{l}_{i} {F}_{x 0} + {l}_{i} {F}_{y 0} + {F}_{x 0} - {M}_{z 0}}{{M}_{F 0}} sin {q}_{i}\end{matrix} ) & ( 52 ) \\ {Δ}_{2} ( dr ) = - {\sum }_{i = 1}^{4} {dr}_{i} {F}_{i} \{ \begin{matrix}\frac{{M}_{z 0} ( {d}_{0}^{2} {F}_{x 0} - {d}_{i} {M}_{z 0} ) + {d}_{i} {M}_{F 0}^{2}}{{M}_{F 0}^{2}} cos {q}_{i} \\ \frac{{M}_{z 0} ( {l}_{0}^{2} {F}_{y 0} + {l}_{i} {M}_{z 0} ) - {l}_{i} {M}_{F 0}^{2}}{{M}_{F 0}^{2}} sin {q}_{i}\end{matrix} \} & ( 53 )\end{matrix}$$

When the tire μ rate rᵢ is changed, the direction of each tire force qᵢ and the performance function are also changed. Therefore, q of Eq. (45) is required to be corrected to q+dq, for example, in order to satisfy the constraints of the target vehicle force and moment when the tire μ rate rᵢ is changed to rᵢ+drᵢ. Here, the amount of change dq representing the direction of each tire force q is expressed as the following Eq. (54)

$$dq = diag [ \frac{1}{\sqrt{{r}_{1} {F}_{1} {X}_{D 1}}} \frac{1}{\sqrt{{r}_{2} {F}_{2} {X}_{D 2}}} \frac{1}{\sqrt{{r}_{3} {F}_{3} {X}_{D 3}}} \frac{1}{\sqrt{{r}_{4} {F}_{4} {X}_{D 4}}} ] \cdot {[ \begin{matrix}{A}_{11} & {A}_{12} & {A}_{13} & {A}_{14} \\ {A}_{21} & {A}_{22} & {A}_{23} & {A}_{24}\end{matrix} ]}^{+} \cdot [ \begin{matrix}{Δ}_{1} ( dr ) \\ {Δ}_{2} ( dr )\end{matrix} ] \qquad ( 54 )$$

Here, dq is expressed as the following equation with the amount of change dqᵢ (=dq₁, dq₂, dq₃, dq₄) of the direction of each tire force.

dq=[dq₁dq₂dq₃dq₄]^{T}

In this embodiment, satisfying the constraints of the target vehicle force and moment is only considered, and therefore the correction is undefined. That is, an indefinite number of the correction methods is proposed; however, this embodiment applies the correction method using the derived pseudo-inverse matrix for simplifying the calculation. At that time, the performance function J of Eq. (25) changes to J+dJ. Here, the amount of change dJ is expressed as the following Eq. (55).

$$dJ = {\sum }_{i = 1}^{4} [ {dr}_{i} {F}_{i} \{ ( {d}_{0}^{2} {F}_{x 0} - {d}_{i} {M}_{z 0} ) cos {q}_{i} + ( {l}_{0}^{2} {F}_{y 0} + {l}_{i} {M}_{z 0} ) sin {q}_{i} \} + {r}_{i} {F}_{i} \{ - ( {d}_{0}^{2} {F}_{x 0} - {d}_{i} {M}_{z 0} ) sin {q}_{i} + ( {l}_{0}^{2} {F}_{y 0} + {l}_{i} {M}_{z 0} ) cos {q}_{i} \} {dq}_{i} ⌋ \qquad ( 55 )$$

The amount of change dJ of the performance function J is therefore expressed as the following Eq. (56) derived from the approximate partial differentiation of the performance function J.

$$\begin{matrix}\frac{\partial J}{\partial r} ≅ [ \begin{matrix}{F}_{1} \{ ( {d}_{0}^{2} {F}_{x 0} - {d}_{1} {M}_{z 0} ) cos {q}_{1} + ( {l}_{0}^{2} {F}_{y 0} + {l}_{1} {M}_{z 0} ) sin {q}_{1} \} \\ {F}_{2} \{ ( {d}_{0}^{2} {F}_{x 0} - {d}_{2} {M}_{z 0} ) cos {q}_{2} + ( {l}_{0}^{2} {F}_{y 0} + {l}_{2} {M}_{z 0} ) sin {q}_{2} \} \\ {F}_{3} \{ ( {d}_{0}^{2} {F}_{x 0} - {d}_{3} {M}_{z 0} ) cos {q}_{3} + ( {l}_{0}^{2} {F}_{y 0} + {l}_{3} {M}_{z 0} ) sin {q}_{3} \} \\ {F}_{4} \{ ( {d}_{0}^{2} {F}_{x 0} - {d}_{4} {M}_{z 0} ) cos {q}_{4} + ( {l}_{0}^{2} {F}_{y 0} + {l}_{i} {M}_{z 0} ) sin {q}_{4} \}\end{matrix} ] + \\ ( diag [ \frac{1}{\sqrt{{r}_{1} {F}_{1} {X}_{D 1}}} \frac{1}{\sqrt{{r}_{2} {F}_{2} {X}_{D 2}}} \frac{1}{\sqrt{{r}_{3} {F}_{3} {X}_{D 3}}} \frac{1}{\sqrt{{r}_{4} {F}_{4} {X}_{D 4}}} ] \cdot \\ { {[ \begin{matrix}{A}_{11} & {A}_{12} & {A}_{13} & {A}_{14} \\ {A}_{21} & {A}_{22} & {A}_{23} & {A}_{24}\end{matrix} ]}^{+} \cdot [ \begin{matrix}{D}_{11} & {D}_{12} & {D}_{13} & {D}_{14} \\ {D}_{21} & {D}_{22} & {D}_{23} & {D}_{24}\end{matrix} ] )}^{τ} \cdot \\ [ \begin{matrix}{r}_{1} {F}_{1} \{ - ( {d}_{0}^{2} {F}_{x 0} - {d}_{1} {M}_{z 0} ) sin {q}_{1} + ( {l}_{0}^{2} {F}_{y 0} + {l}_{1} {M}_{z 0} ) cos {q}_{1} \} \\ {r}_{2} {F}_{2} \{ - ( {d}_{0}^{2} {F}_{x 0} - {d}_{2} {M}_{z 0} ) sin {q}_{2} + ( {l}_{0}^{2} {F}_{y 0} + {l}_{2} {M}_{z 0} ) cos {q}_{2} \} \\ {r}_{3} {F}_{3} \{ - ( {d}_{0}^{2} {F}_{x 0} - {d}_{3} {M}_{z 0} ) sin {q}_{3} + ( {l}_{0}^{2} {F}_{y 0} + {l}_{3} {M}_{z 0} ) cos {q}_{3} \} \\ {r}_{4} {F}_{4} \{ - ( {d}_{0}^{2} {F}_{x 0} - {d}_{4} {M}_{z 0} ) sin {q}_{4} + ( {l}_{0}^{2} {F}_{y 0} + {l}_{4} {M}_{z 0} ) cos {q}_{4} \}\end{matrix} ] \\ = [ \begin{matrix}{F}_{1} \{ ( {d}_{0}^{2} {F}_{x 0} - {d}_{1} {M}_{z 0} ) cos {q}_{1} + ( {l}_{0}^{2} {F}_{y 0} + {l}_{1} {M}_{z 0} ) sin {q}_{1} \} \\ {F}_{2} \{ ( {d}_{0}^{2} {F}_{x 0} - {d}_{2} {M}_{z 0} ) cos {q}_{2} + ( {l}_{0}^{2} {F}_{y 0} + {l}_{2} {M}_{z 0} ) sin {q}_{2} \} \\ {F}_{3} \{ ( {d}_{0}^{2} {F}_{x 0} - {d}_{3} {M}_{z 0} ) cos {q}_{3} + ( {l}_{0}^{2} {F}_{y 0} + {l}_{3} {M}_{z 0} ) sin {q}_{3} \} \\ {F}_{4} \{ ( {d}_{0}^{2} {F}_{x 0} - {d}_{4} {M}_{z 0} ) cos {q}_{4} + ( {l}_{0}^{2} {F}_{y 0} + {l}_{i} {M}_{z 0} ) sin {q}_{4} \}\end{matrix} ] + \\ {( {[ \begin{matrix}{A}_{11} & {A}_{12} & {A}_{13} & {A}_{14} \\ {A}_{21} & {A}_{22} & {A}_{23} & {A}_{24}\end{matrix} ]}^{+} \cdot [ \begin{matrix}{D}_{11} & {D}_{12} & {D}_{13} & {D}_{14} \\ {D}_{21} & {D}_{22} & {D}_{23} & {D}_{24}\end{matrix} ] )}^{τ} \\ [ \begin{matrix}\sqrt{\frac{{r}_{1} {F}_{1}}{{X}_{D 1}}} \{ - ( {d}_{0}^{2} {F}_{x 0} - {d}_{1} {M}_{z 0} ) sin {q}_{1} + ( {l}_{0}^{2} {F}_{y 0} + {l}_{1} {M}_{z 0} ) cos {q}_{1} \} \\ \sqrt{\frac{{r}_{2} {F}_{2}}{{X}_{D 2}}} \{ - ( {d}_{0}^{2} {F}_{x 0} - {d}_{2} {M}_{z 0} ) sin {q}_{2} + ( {l}_{0}^{2} {F}_{y 0} + {l}_{2} {M}_{z 0} ) cos {q}_{2} \} \\ \sqrt{\frac{{r}_{3} {F}_{3}}{{X}_{D 3}}} \{ - ( {d}_{0}^{2} {F}_{x 0} - {d}_{3} {M}_{z 0} ) sin {q}_{3} + ( {l}_{0}^{2} {F}_{y 0} + {l}_{3} {M}_{z 0} ) cos {q}_{3} \} \\ \sqrt{\frac{{r}_{4} {F}_{4}}{{X}_{D 4}}} \{ - ( {d}_{0}^{2} {F}_{x 0} - {d}_{4} {M}_{z 0} ) sin {q}_{4} + ( {l}_{0}^{2} {F}_{y 0} + {l}_{4} {M}_{z 0} ) cos {q}_{4} \}\end{matrix} ]\end{matrix} \qquad ( 56 )$$

Here, D₁ᵢ and D₂ᵢ are defined as the following Eqs. (57) and (58).

$$\begin{matrix}{D}_{1 i} = - {F}_{i} ( \begin{matrix}\frac{- {d}_{i} {F}_{x 0} - {d}_{i} {F}_{y} - {F}_{y 0} - {M}_{z 0}}{{M}_{F 0}} cos {q}_{i} + \\ \frac{{l}_{i} {F}_{x 0} + {l}_{i} {F}_{y 0} + {F}_{x 0} - {M}_{z 0}}{{M}_{F 0}} sin {q}_{i}\end{matrix} ) & ( 57 ) \\ {D}_{2 i} = - {F}_{i} \{ \begin{matrix}\frac{{M}_{z 0} ( {d}_{0}^{2} {F}_{x 0} - {d}_{i} {M}_{z 0} ) + {d}_{i} {M}_{F 0}^{2}}{{M}_{F 0}^{2}} cos {q}_{i} \\ \frac{{M}_{z 0} ( {l}_{0}^{2} {F}_{y 0} + {l}_{i} {M}_{z 0} ) - {l}_{i} {M}_{F 0}^{2}}{{M}_{F 0}^{2}} sin {q}_{i}\end{matrix} \} & ( 58 )\end{matrix}$$

In this embodiment, the interior point is searched according to the steepest-descent method such that r (=[r₁r₂r₃r₄]^{T}) is changed as the following Eq. (59) in the range 0-1, and the repeat operation proceeds to the next step. Here, r₀ denotes the previous value of the tire μ rate r in the repeat operation, and k denotes a positive constant. By this method, the tire μ rate r is corrected to be smaller in case that the performance function J is changed to be larger.

$$r = \{ \begin{matrix}0 & ( {r}_{0} + k \frac{\partial J}{\partial r} < 0 ) \\ {r}_{0} + k \frac{\partial J}{\partial r} & ( 0 \leq {r}_{0} + k \frac{\partial J}{\partial r} \leq 1 ) \\ 1 & ( {r}_{0} + k \frac{\partial J}{\partial r} > 1 )\end{matrix} \qquad ( 59 )$$

In this case, with the change of the tire μ rate r, q is corrected to q+dq in order to satisfy the constraints of the vehicle force and moment. Here, dq is expressed as the following Eq. (54).

$$dq = diag [ \frac{1}{\sqrt{{r}_{1} {F}_{1} {X}_{D 1}}} \frac{1}{\sqrt{{r}_{2} {F}_{2} {X}_{D 2}}} \frac{1}{\sqrt{{r}_{3} {F}_{3} {X}_{D 3}}} \frac{1}{\sqrt{{r}_{4} {F}_{4} {X}_{D 4}}} ] \cdot {[ \begin{matrix}{A}_{11} & {A}_{12} & {A}_{13} & {A}_{14} \\ {A}_{21} & {A}_{22} & {A}_{23} & {A}_{24}\end{matrix} ]}^{+} \cdot [ \begin{matrix}{Δ}_{1} ( dr ) \\ {Δ}_{2} ( dr )\end{matrix} ] \\ dr = r - r - {r}_{0} \qquad ( 54 )$$

The upper limit γ of μ rate is calculated according to the above Eq. (49) by using the angle qᵢ derived as described above.

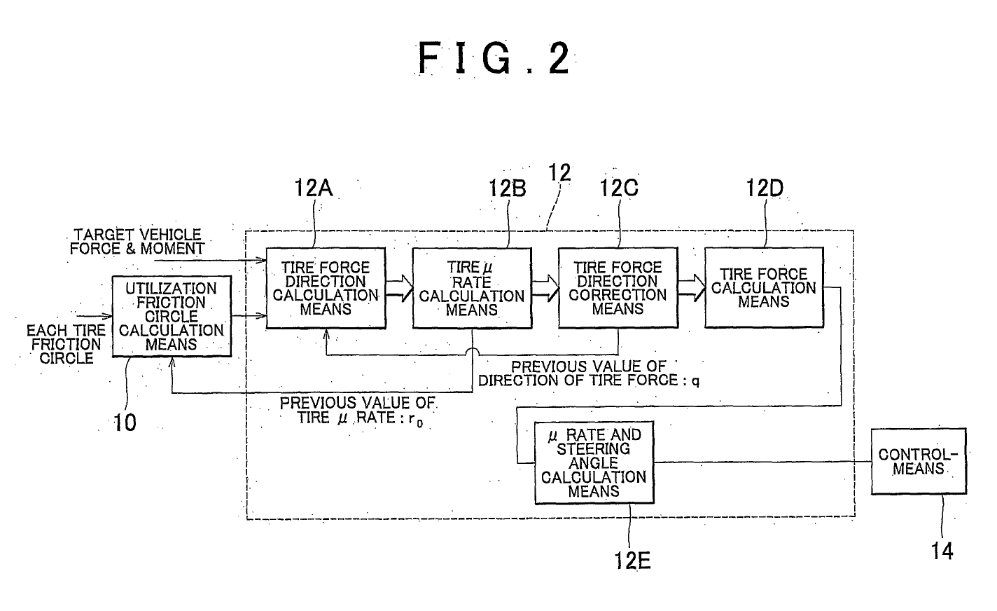

A specific structure of this embodiment using the above principle will be described next with reference to FIG. 2. As shown in the drawing, this embodiment is provided with utilization friction circle calculation means 10 for calculating the size of the utilization friction circle of each tire defined as a product rᵢFᵢ in Eqs. (9) and (10) by multiplying the size of the tire friction circle Fᵢ, which is the maximum tire force estimated from factors such as each wheel speed dynamics and self-aligning torque, by the previous value of the tire μ rate rᵢ calculated in the previous step of the repeat operation.

The calculation means 10 is connected to a tire force calculation device 12 for calculating the tire force of each wheel and each tire μ rate rᵢ from the size of the utilization friction circle and the target vehicle force and moment, which are the target values of vehicle longitudinal force, vehicle lateral force, and yaw moment. This calculation device 12 is connected with control means 14 for attaining the calculated each tire force with the vehicle integrated control.

The tire force calculation device 12 is provided with tire force direction calculation means 12A for calculating the direction of each tire force qᵢ for minimizing the upper limit γ of μ rate according to the above Eq. (45) with the constraints for achieving the target vehicle force and moment using the target vehicle force and moment and the utilization friction circle of each tire calculated with the utilization friction circle calculation means 10.

The calculation means 12A is connected with tire μ rate calculation means 12B for calculating the tire μ rate rᵢ according to the above Eq. (59) to decrease the upper limit γ of μ rate with the constraints for achieving the target vehicle force and moment. The calculation means 12B changes the tire μ rate rᵢ in the range 0-1. When the performance function J varies greatly, the calculation means 12B changes the tire μ rate rᵢ to be small.

The calculation means 12B also outputs the previous value in the repeat operation of the tire μ rate by the calculation means 12B to the utilization friction circle calculation means 10.

In addition, the calculation means 12B is connected with tire force direction correction means 12C for correcting the direction of each tire force along with the calculation of the tire μ rate according to the Eq. (54) and corresponding to the tire μ rate in order to achieve the target vehicle force and moment.

The correction means 12C outputs the previous value of the direction of each tire force to the tire force direction calculation means 12A.

The correction means 12C is connected with tire force calculation means 12D for calculating each tire force from the tire μ rate, the corrected direction of each tire force, and the minimized upper limit of μ rate. This calculation means 12D calculates tire forces Fₓᵢ and F_{yi} at each wheel according to the Eqs. (9) and (10).

The calculation means 12D is connected with μ rate and steering angle calculation means 12E for calculating a longitudinal μ rate and an equalized steering angle for the right and left wheels.

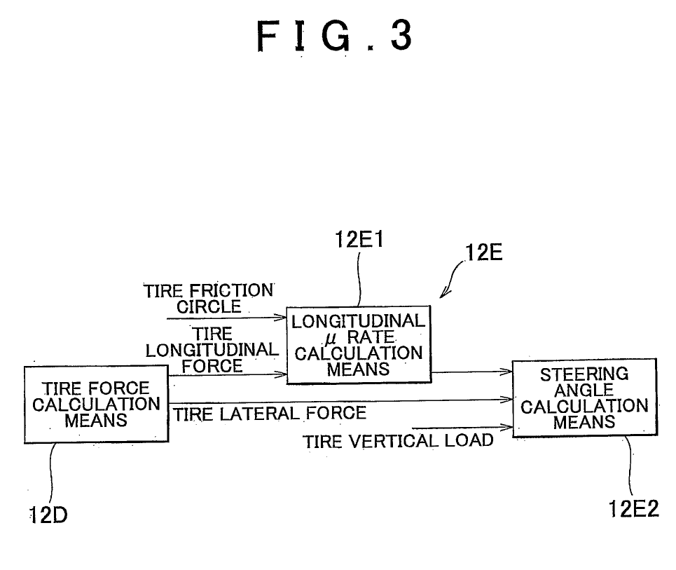

As shown in FIG. 3, this calculation means 12E includes longitudinal μ rate calculation means 12E1 and steering angle calculation means 12E2. The longitudinal μ rate calculation means 12E1 calculates the longitudinal μ rate that the longitudinal forces of each tire calculated by the tire force calculation means 12D are normalized with the size of the friction circle representing the maximum tire force at each wheel. The steering angle calculation means 12E2 calculates the equalized steering angle for the right and left wheels based on the longitudinal μ rate of each tire calculated by the longitudinal μ rate calculation means 12E1, the lateral force at each tire, and the vertical load at each tire.

The vertical load at each tire may be measured by a sensor disposed at each wheel and estimated based on the longitudinal acceleration, the lateral acceleration, the height of the center of gravity of the vehicle from the ground, and the vehicle weight when stopping.

Next, the principle of calculating the equalized steering angle for the right and left wheels in the μ rate and steering angle calculation means 12E will be described.

First, in order to simplify the expression of the tire longitudinal and lateral forces as the tire force according to a brush model, the longitudinal slip κₓ the lateral slip κ_{y} and combined slip κ are defined as follows.

$$\begin{matrix}{κ}_{x} = \frac{{v}_{x} - {v}_{w}}{{v}_{w}} & ( 60 ) \\ {κ}_{y} = \frac{{K}_{β} {v}_{y}}{{K}_{s} {v}_{w}} & ( 61 ) \\ κ = \sqrt{{κ}_{x}^{2} + {κ}_{y}^{2}} & ( 62 )\end{matrix}$$

Here, vₓ is longitudinal tire position speed, v_{y} is lateral tire position speed, v_{w} is tire rotational speed, Kₛ is longitudinal tire stiffness, and K_{β} is lateral tire stiffness.

The direction θ of tire force coincides with the direction of slip, that is, the direction θ is assumed to satisfy the following Eq. (63).

$$tan θ ≡ \frac{{F}_{y}}{{F}_{x}} = \frac{{κ}_{y}}{{κ}_{x}} \qquad ( 63 )$$

The tire longitudinal force Fₓ and lateral force F_{y} are expressed as the following Eqs. (64) to (67) in accordance with a tire gripping range and a full slipping range.

$$\begin{matrix}( Gripping range ) & \\ {ξ}_{s} = 1 - \frac{{K}_{s}}{3 μ {F}_{z}} κ > 0 & \\ {F}_{x} = μ {F}_{z} cos θ \cdot ( 1 - {ξ}_{s}^{3} ) & ( 64 ) \\ {F}_{y} = μ {F}_{z} sin θ \cdot ( 1 - {ξ}_{s}^{3} ) & ( 65 ) \\ ( Full slipping range ) & \\ {ξ}_{s} = 1 - \frac{{K}_{s}}{3 μ {F}_{z}} κ < 0 & \\ {F}_{x} = μ {F}_{z} cos θ & ( 66 ) \\ {F}_{y} = μ {F}_{z} sin θ & ( 67 )\end{matrix}$$

Here, μ denotes road friction, and F_{z} denotes a vertical load.

The longitudinal and lateral tire stiffness are proportional to the vertical load, that is, the stiffness is assumed to be expressed as the following Eqs. (68) and (69).

Kₛ=Kₓ₀F_{z}(68)

K_{β}=K_{β0}F_{z}(69)

The lateral force F_{y} in the gripping range is expressed as the following Eq. (70) using the above Eqs. (63), (65), and (68).

$$\begin{matrix}{F}_{y} = - μ {F}_{z} \frac{{κ}_{y}}{\sqrt{{κ}_{x}^{2} + {κ}_{y}^{2}}} \{ 1 - {( 1 - \frac{{K}_{s 0}}{3 μ} \sqrt{{κ}_{x}^{2} + {κ}_{y}^{2}} )}^{3} \} \\ = \frac{- μ {F}_{z} {κ}_{y}}{\sqrt{{κ}_{x}^{2} + {κ}_{y}^{2}}} \{ 3 \frac{{K}_{s 0}}{3 μ} \sqrt{{κ}_{x}^{2} + {κ}_{y}^{2}} - 3 {( \frac{{K}_{s 0}}{3 μ} \sqrt{{κ}_{x}^{2} + {κ}_{y}^{2}} )}^{2} + {( \frac{{K}_{s 0}}{3 μ} \sqrt{{κ}_{x}^{2} + {κ}_{y}^{2}} )}^{3} \} \\ = - {K}_{s 0} {F}_{z} {κ}_{y} \{ 1 - \frac{{K}_{s 0}}{3 μ} \sqrt{{κ}_{x}^{2} + {κ}_{y}^{2}} + \frac{{K}_{s 0}^{2}}{27 {μ}^{2}} ( {κ}_{x}^{2} + {κ}_{y}^{2} ) \}\end{matrix} \qquad ( 70 )$$

The above Eq. (70) shows that the lateral force F_{y} is proportional to the vertical load and more specifically, proportional only to the vertical load in the vicinity of the origin where the slip is small without being affected by road friction.

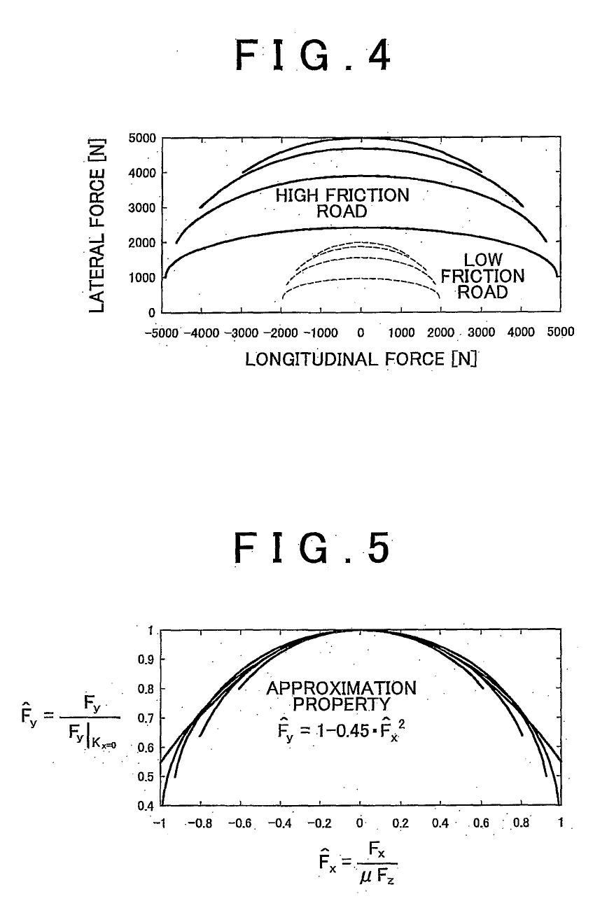

The equalization of the steering angles for the right and left wheels will be described next. FIG. 4 shows the relation between the lateral and longitudinal forces under a constant lateral slip such that tire force characteristics are calculated according to the above Eqs. (64) and (65) assuming that the lateral slip is constant.

In the integrated steering-traction/braking control for controlling the steering angle and the traction or the steering angle and the braking force in an integrated manner, the target tire force is attained with the control of the steering angle and the traction/braking force in the gripping range. Therefore, FIG. 4 shows the relation between the lateral force F_{y} and the longitudinal force Fₓ in the gripping range, that is, 0=ξₛ=1.

In FIG. 4, solid lines indicate the characteristics on a high friction road (μ=1.0), and dashed lines indicate the characteristics on a low friction road (μ=0.4).

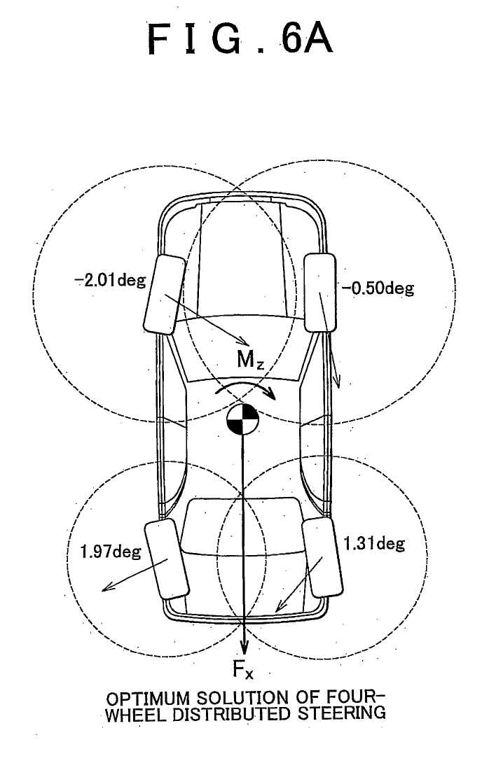

FIG. 5 shows a chart illustrating the characteristic relation between normalized lateral and longitudinal forces such that the lateral force F_{y} indicated in the vertical axis of FIG. 4 is divided and normalized by the maximum lateral force, that is, the value of (κₓ=0) when the longitudinal slip equals to zero, and the longitudinal force Fₓ indicated in the horizontal axis of FIG. 4 is represented with the lateral force (longitudinal μ rate) divided and normalized by the size of friction circle, that is, μFₓ.

According to the normalization, the relation between the longitudinal μ rate (normalized longitudinal force) in case of the constant lateral slip and the normalized lateral force may be approximated with approximately one parabola independent of the value of lateral slip or the road friction. In this embodiment, the characteristics approximated with the parabola may be approximated by the following Eq. (71).

\hat{F}_{y}=1−0.45·\hat{F}ₓ² (71)

Although the longitudinal μ rate is expressed with a quadratic function of normalized lateral force, the longitudinal μ rate may be approximated by other functions such as a quartic function or may be shown in a map.

According to FIG. 5, the ratio of lateral force generated in case that the lateral slips of the right and left tires have the same magnitude is express as the following Eq. (72).

F_{yl}:F_{yR}=\hat{F}_{yL}·F_{yL}|_{κ}_{ₓ}₌₀:\hat{F}_{yR}·F_{yR}|_{κ}_{ₓ}₌₀ (72)

Considering the Eq. (72) and Eq. (71) defining the relation between the normalized lateral force and the longitudinal μ rate and the fact that the lateral force when the longitudinal slip equals to zero is approximately proportional to the vertical load as indicated in the above Eq. (70), the ratio of lateral force for right and left tires is expressed as the following Eq. (73).

$$\begin{matrix}{F}_{yL} \text{:} {F}_{yR} ≡ {\hat{F}}_{yL} \cdot {F}_{2 L} \text{:} {\hat{F}}_{yR} \cdot {F}_{zR} \\ ≅ {F}_{zL} \{ 1 - 0.45 \cdot {( \frac{{F}_{xL}}{{μ}_{L} {F}_{zL}} )}^{2} \} \text{:} {F}_{zR} \{ 1 - 0.45 \cdot {( \frac{{F}_{xR}}{{μ}_{R} {F}_{zR}} )}^{2} \}\end{matrix} \qquad ( 73 )$$

Here, the subscripts “L” and “R” denote the left and right wheels, respectively. If the redistribution of the sum of lateral force commanding values for the right and left tires calculated with optimum distribution is implemented according to the Eq. (73), the integral control is attained for equalizing the lateral slip of the right and left tires, that is, for achieving the target vehicle force and moment with the equalized steering angle of the right and left wheels.

More specifically, if the longitudinal and lateral forces of the right and left tires calculated by an optimum distribution algorithm of tire forces are F_{xL}, F_{xR}, F_{yL}, and F_{yR}, respectively, the lateral forces are calculated with the following Eqs. (74) and (75).

$$\begin{matrix}{F}_{yL}^{′} = \frac{{F}_{zL} \{ 1 - 0.45 \cdot {( \frac{{F}_{xL}}{{μ}_{L} {F}_{zL}} )}^{2} \} ( {F}_{yL} + {F}_{yR} )}{\begin{matrix}{F}_{zL} \{ 1 - 0.45 \cdot {( \frac{{F}_{xL}}{{μ}_{L} {F}_{zL}} )}^{2} \} + \\ {F}_{zR} \{ 1 - 0.45 \cdot {( \frac{{F}_{xR}}{{μ}_{R} {F}_{zR}} )}^{2} \}\end{matrix}} & ( 74 ) \\ {F}_{yR}^{′} = \frac{{F}_{zR} \{ 1 - 0.45 \cdot {( \frac{{F}_{xR}}{{μ}_{L} {F}_{zR}} )}^{2} \} ( {F}_{yL} + {F}_{yR} )}{\begin{matrix}{F}_{zL} \{ 1 - 0.45 \cdot {( \frac{{F}_{xL}}{{μ}_{L} {F}_{zL}} )}^{2} \} + \\ {F}_{zR} \{ 1 - 0.45 \cdot {( \frac{{F}_{xR}}{{μ}_{R} {F}_{zR}} )}^{2} \}\end{matrix}} & ( 75 )\end{matrix}$$

In addition, the lateral slips at that time are expressed as the following Eqs. (76) and (77).

$$\begin{matrix}{κ}_{yL} = - \frac{3 {μ}_{L} {F}_{yL}^{′}}{{K}_{s 0} \sqrt{{F}_{xL}^{2} + {F}_{yL}^{′2}}} ( 1 - {( 1 - \frac{\sqrt{{F}_{xL}^{2} + {F}_{yL}^{′2}}}{{μ}_{L} {F}_{zL}} )}^{1 / 3} ) & ( 76 ) \\ {κ}_{yR} = - \frac{3 {μ}_{R} {F}_{yR}^{′}}{{K}_{s 0} \sqrt{{F}_{xR}^{2} + {F}_{yR}^{′2}}} ( 1 - {( 1 - \frac{\sqrt{{F}_{xR}^{2} + {F}_{yR}^{′2}}}{{μ}_{R} {F}_{zR}} )}^{1 / 3} ) & ( 77 )\end{matrix}$$

Thus, the slip angles β_{L} and β_{R} of tires are expressed as the following Eqs. (78) and (79).

$$\begin{matrix}{β}_{L} = {tan}^{- 1} \{ \frac{3 {μ}_{L} {F}_{yL}^{′}}{{K}_{β 0} \sqrt{{F}_{xL}^{2} + {F}_{yL}^{′2}}} ( 1 - {( 1 - \frac{\sqrt{{F}_{xL}^{2} + {F}_{yL}^{′2}}}{{μ}_{L} {F}_{zL}} )}^{1 / 3} ) \} & ( 78 ) \\ {β}_{R} = {tan}^{- 1} \{ \frac{3 {μ}_{R} {F}_{yR}^{′}}{{K}_{β 0} \sqrt{{F}_{xR}^{2} + {F}_{yR}^{′2}}} ( 1 - {( 1 - \frac{\sqrt{{F}_{xR}^{2} + {F}_{yR}^{′2}}}{{μ}_{R} {F}_{zR}} )}^{1 / 3} ) \} & ( 79 )\end{matrix}$$

The steering angles d_{L} and d_{R} are expressed as the following Eqs. (80) and (81) by using a vehicle slip angle β and yaw angular velocity r.

$$\begin{matrix}{δ}_{L} = β + lr + {tan}^{- 1} \{ \frac{3 {μ}_{L} {F}_{yL}^{′}}{{K}_{β 0} \sqrt{{F}_{xL}^{2} + {F}_{yL}^{′2}}} ( 1 - {( 1 - \frac{\sqrt{{F}_{xL}^{2} + {F}_{yL}^{′2}}}{{μ}_{L} {F}_{zL}} )}^{1 / 3} ) \} & ( 80 ) \\ {δ}_{R} = β + lr + {tan}^{- 1} \{ \frac{3 {μ}_{R} {F}_{yR}^{′}}{{K}_{β 0} \sqrt{{F}_{xR}^{2} + {F}_{yR}^{′2}}} ( 1 - {( 1 - \frac{\sqrt{{F}_{xR}^{2} + {F}_{yR}^{′2}}}{{μ}_{R} {F}_{zR}} )}^{1 / 3} ) \} & ( 81 )\end{matrix}$$

Here, l is a distance from an axle to the center of gravity, which is L_{f} in case of a front axle and -Lᵣ in case of a rear axle. The right and left steering angles obtained from Eqs. (80) and (81) may differ slightly from each other due to the approximate result of the tire characteristics. Therefore, this embodiment uses the average value of the right and left steering angles as a steering angle. The steering angle may be calculated in consideration of Ackerman Mechanism.

Then, the coordinate control between the traction and the steering angle or between the braking force and the steering angle of the vehicle is performed by using the traction/braking force of each tire and the steering angle of each wheel, calculated as described above, as the operation amount.

When performing the coordinate control, the control means controls a steering actuator and a traction/braking actuator and also controls the steering angle of each wheel required to attain the each target tire force or the steering angle and the traction/braking force of each wheel.

For the control means 14, braking force control means, traction control means, front wheel steering control means, or rear wheel steering control means described as follows may be used.

The braking force control means may include control means used in a so-called Electronic Stability Control (ESC) that controls the braking force of each wheel independently of the driver's operation, control means mechanically separated from the driver's operation for arbitrarily controlling the braking force of each wheel through a signal line (so-called Brake-by-Wire), and other means.

The traction control means may include control means for controlling the traction by controlling engine torque through the throttle opening, retarding the angle of an ignition timing advance, or the amount of fuel injection, control means for controlling the traction by controlling the gear position of a transmission, control means for controlling the traction in at least one of lateral and longitudinal directions by controlling a torque transfer system, and other means.

The front wheel steering control means may include controlling means for controlling the steering angle of the right and left front wheels to the equalized steering angle overlapped with the driver's operation of the steering wheel, control means mechanically separated from the driver's operation for controlling the steering angle of the right and left front wheels to the equalized steering angle independently of the operation of the steering wheel (so-called Steer-by Wire), and other means.

The rear wheel steering control means may include controlling means for controlling the steering angle of the right and left rear wheels to the equalized steering angle corresponding to the driver's operation of the steering wheel, control means mechanically separated from the driver's operation for controlling the steering angle of the right and left rear wheels to the equalized steering angle independently of the operation of the steering wheel, and other means.

The aforementioned utilization friction circle calculation means 10, the tire force calculation device 12 (the tire force direction calculation means 12A, the tire μ rate calculation means 12B, the tire force direction correction means 12C, the tire force calculation means 12D, and the μ rate and steering angle calculation means 12E), and the control means 14 may be configured with one or plural computer(s). In this case, the computer stores a program for allowing the computer to function as the aforementioned means.

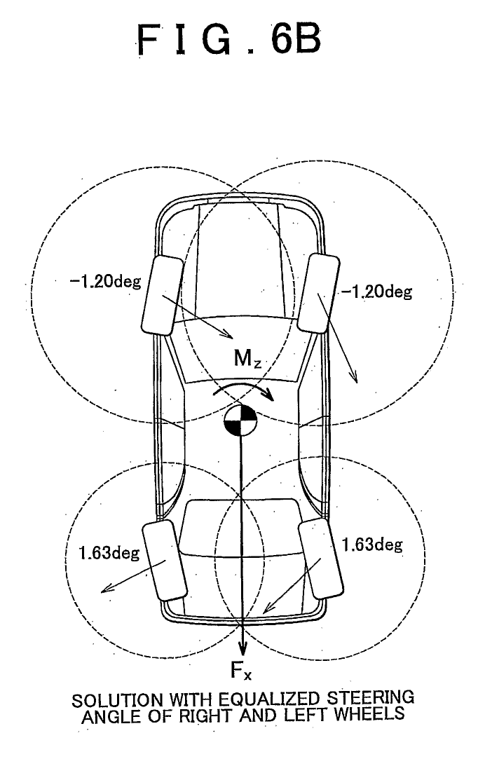

The simulation result of the above embodiment will be described next. FIG. 6 shows tire forces and steering angles in case of requiring the yaw moment M_{z0} of −8000 [Nm] during the straight braking (Fₓ₀=−5000 [N]) on a medium friction road (μ=0.5).

FIG. 6A shows an optimum tire force and the steering angle of each wheel for attaining the optimum tire force on the assumption of the four-wheel distributed steering. In this case, the upper limit of the μ rate is 0.77. FIG. 6B shows the results of redistribution of the lateral forces of the right and left tires and equalization of the steering angles of the right and left wheels, using the algorithm of the embodiment to equalize the steering angles of the right and left wheels. In this case, the steering angle of the front wheels is −1.20, the steering angle of the rear wheels is 1.63, and the upper limit of the μ rate is 0.84. Although the upper limit of the μ rate for each wheel increases about 9% due to the redistribution, the equalization of right and left steering angles is achieved.

While the invention has been described with reference to example embodiments thereof, it should be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1-8. (canceled)

9: A vehicle dynamics control system, comprising:
a tire force calculation section that calculates a tire force at each wheel to achieve a target vehicle force and moment, which indicates a target vehicle longitudinal force, a target vehicle lateral force, and a target yaw moment;
a longitudinal μ rate calculation section that calculates a longitudinal μ rate, which is obtained by normalizing a tire longitudinal force component of each tire force with a size of each tire friction circle representing the maximum tire force of each wheel;
a steering angle calculation section that calculates a steering angle equalized for right and left wheels based on the longitudinal μ rate at each tire, a tire lateral force of each tire force, and a vertical load at each tire; and
a control section that controls vehicle dynamics based on the calculated steering angle.

10: The vehicle dynamics control system according to claim 9, wherein
the steering angle calculation section calculates the steering angle equalized for the right and left wheels by approximating with a parabola the relation between the longitudinal μ rate under constant lateral slip and a normalized tire lateral force, which is obtained by normalizing the tire lateral force at each tire with the maximum tire lateral force, and by distributing an optimum tire lateral force at each tire to achieve the target vehicle force and moment assuming that the tire lateral force is proportional to a vertical load when a longitudinal slip equals to zero and based on a ratio of the tire lateral force of each tire when lateral slips of right and left tires are the same.

11: The vehicle dynamics control system according to claim 9, further comprising:
a tire force direction calculation section that calculates a direction of each tire force to minimize an upper limit of μ rate at each tire with constraints for achieving the target force and moment by using the target vehicle force and moment and the size of the friction circle;
a tire μ rate calculation section that calculates a tire μ rate that indicates a ratio relative to the upper limit of μ rate at each tire to decrease the upper limit of μ rate with constraints for achieving the target force and moment; and
a tire force direction correction section that corrects the direction of each tire force corresponding to the tire μ rate, wherein
the tire force calculation section calculates the each tire force from the tire μ rate, corrected direction of each tire force, and minimized upper limit of μ rate at each tire.

12: The vehicle dynamics control system according to claim 10, further comprising:
a tire force direction calculation section that calculates a direction of each tire force to minimize an upper limit of μ rate at each tire with constraints for achieving the target force and moment by using the target vehicle force and moment and the size of the friction circle;
a tire μ rate calculation section that calculates a tire/rate that indicates a ratio relative to the upper limit μ rate at each tire to decrease the upper limit of μ rate with constraints for achieving the target force and moment; and
a tire force direction correction section that corrects the direction of each tire force corresponding to the tire μ rate, wherein
the tire force calculation section calculates the each tire force from the tire μ rate, corrected direction of each tire force, and minimized upper limit of μ rate at each tire.

13: A method of controlling vehicle dynamics, comprising:
calculating a tire force of each-wheel to achieve target vehicle force and moment, which indicates a target vehicle longitudinal force, a target vehicle lateral force, and a target yaw moment;
calculating a longitudinal μ rate, which is obtained by normalizing a tire longitudinal force of each tire force with a size of each tire friction circle representing the maximum tire force of each wheel;
calculating an equalized steering angle for right and left wheels based on the longitudinal μ rate at each tire, a lateral force of each tire force, and a vertical load at each tire; and
controlling vehicle dynamics based on the calculated steering angle.

14: The method of controlling vehicle dynamics according to claim 13, wherein
a steering angle equalized for right and left wheels is calculated by approximating with a parabola the relation between the longitudinal μ rate under constant lateral slip and a normalized lateral force, which is obtained by normalizing the lateral force of each tire with the maximum lateral force, and by distributing an optimum lateral force at each tire to achieve the target vehicle force and moment assuming that the lateral force is proportional to a vertical load when a longitudinal slip equals to zero and based on a ratio of the lateral force of each tire when lateral slips of right and left tires are the same.

15: The method of controlling vehicle dynamics according to claim 13, further comprising:
calculating a direction of each tire force to minimize an upper limit of μ rate at each tire with constraints for achieving the target force and moment by using the target vehicle force and moment and the size of the friction circle;
calculating a tire μ rate that indicates a ratio relative to the upper limit of μ rate at each tire to decrease the upper limit of μ rate with constraints for achieving the target force and moment; and
correcting the direction of each tire force corresponding to the tire μ rate, wherein
the calculating a tire force of each wheel is performed based on the tire μ rate, corrected direction of each tire force, and minimized upper limit of μ rate at each tire.

16: The method of controlling vehicle dynamics according to claim 15, further comprising:
calculating a direction of each tire force to minimize an upper limit of μ rate at each tire with constraints for achieving the target force and moment by using the target vehicle force and moment and the size of the friction circle;
calculating a tire μ rate that indicates a ratio relative to the upper limit of μ rate at each tire to decrease the upper limit of μ rate with constraints for achieving the target force and moment; and
correcting the direction of each tire force corresponding to the tire μ rate, wherein
the calculating a tire force of each, wheel is performed based on the tire μ rate, corrected direction of each tire force, and minimized upper limit of μ rate at each tire.
